(19) United States
(12) Patent Application Publication
(10) Pub. No.: US 2009/0319187 A1
(43) Pub. Date: Dec. 24, 2009

(54) Generating Geocoded Targeted Web Advertisements

(75) Inventors: Robert F. Deeming, Brooklyn, NY (US); Steven B. Johnson, Brooklyn, NY (US)

Correspondence Address: FENWICK & WEST LLP, SILICON VALLEY CENTER, 801 CALIFORNIA STREET, MOUNTAIN VIEW, CA, 94041, US

(73) Assignee: Outside.In, Inc., Brooklyn, NY (US)

(21) Appl. No.: 12/144,538

(22) Filed: Jun. 23, 2008

(51) Int. Cl. G06Q 30/00; G06Q 10/00; G01C 21/00

(52) U.S. Cl. 701/300; 705/10; 705/14.58

(57) ABSTRACT

A system and a method are disclosed for presenting users with web advertisements that are dynamically adjusted based upon a geographic location determined within the content of the web page that the web advertisement will appear. An analysis module determines a geographic location from the content of a web page. The analysis module determines coordinates associated with the geographic location. An advertisement search module determines geographic specific advertisements based on the coordinates. An advertisement generation module generates a geocoded targeted web advertisement based at least in part on geographic specific advertisements.

### BACKGROUND

1. Field of Art

The disclosure generally relates to the field of advertisements, and more particularly to location-specific web advertisements.

2. Description of the Related Art

With the rapid development of electronic commerce, the number of Internet companies offering web advertising has increased dramatically. Historically, Internet companies began placing web advertisements in web pages without reflecting the user's interest or current context. To personalize the web advertisements, Internet companies began selecting various advertisements in response to the user's geographic location. Typically, the geographic location is at a city level and is determined based on the internet protocol (IP) address of the website being browed by the user. Additionally, Internet companies typically select city level web advertisements based on the knowledge that particular websites cater only to a specific city, such as a website related to a local newspaper for the city of Mountain View, Calif. These advertisements reflect information that is pertinent to users within the city.

While conventional web advertising systems allow placement of advertisements that generalize the interests of users at a city level, the conventional web advertising systems do not take into consideration locations at a greater level of detail. Conventional web advertising systems do not take into account that business operations and activities can change from one street to the next, or between different neighborhoods as each neighborhood typically has its own characteristics such as culture, diversity or purchasing habits that are common to only that particular neighborhood. Conventional web advertising systems present users web advertisements that simply may not be relevant as they only focus on users at a city level and do not account for the characteristics of users within the neighborhood that may be represented by the promotions or sales that vary from one store location to the next. Thus, users may not be inclined to seek additional information regarding the displayed web advertisements.

Thus, there is lacking, inter alia, a method and system that presents users web advertisements that are targeted specifically to the geographic location of the user based on a geographic location associated with web pages being viewed by the user.

### SUMMARY

One embodiment of a disclosed system is for presenting users with web advertisements that are dynamically adjusted based upon a geographic location determined within the content of the web page that the web advertisement will appear. The method allows web advertisers the ability to create for a company a single advertisement campaign which can be automatically customized to reflect user context based on the geographic location associated with the content of the web page. Automatically customizing web advertisements beneficially creates a more effective advertisement campaign as the web advertisements may be adjusted to more accurately reflect the interests of users associated with a geographic location such as a specific neighborhood. Web advertisers simply create a general advertisement campaign that will automatically adjust to create a geographic specific advertisement for each location of that company. The geographic specific advertisement reflects information that is relevant to the specific location of the company, saving web advertisers both time and money as individual advertisements for each location do not need to be created. Additionally, users are presented web advertisements that are more likely to assist the users in their personal needs.

In one embodiment, a user is presented a web page responsive to a user search query performed by the user in a search engine or simply from entering a universal resource locator (URL) link into a browser. An advertisement hosting website, which is responsible for placing web advertisements within the requested web page, comprises an analysis module which determines a geographic location associated with the user from the content of the web page. The analysis module determines latitude and longitude coordinates of a centroid or centerpoint of the geographic location by retrieving geographic information stored in a geographic information database. An advertisement search module determines specific advertisements of a particular company location near the centroid. In one embodiment, the advertisement search module determines a general advertisement campaign associated with the company. An advertisement generation module generates a geocoded targeted web advertisement using the general web advertisement campaign and specific advertisements related to the geographic location determined by the advertisement hosting website for display to the user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (FIG.) 1 illustrates one embodiment of a block diagram of the system architecture of the present invention.

FIG. 2 illustrates one embodiment for a flow diagram describing a method to generate a geocoded targeted web advertisement.

FIG. 3 illustrates one embodiment for a flow diagram describing a method to determine web advertisements associated with a particular neighborhood.

FIGS. 4 and 5 illustrate one embodiment of a web page including a geocoded targeted web advertisement.

FIG. 6 illustrates one embodiment of a geocoded targeted web advertisement.

FIG. 7 illustrates one embodiment of a diagram indicating various neighborhoods depicted by trapezoidal regions.

FIG. 8 illustrates one embodiment of a geographic specific advertisement table.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system or method for purposes of illustration only. One skilled in the art will readily recognize from the following description that alternative embodiments of the structures and methods illustrated herein may be employed without departing from the principles described herein.

### System Overview

Referring now to FIG. 1, there is shown the system architecture of an embodiment of an advertisement hosting website 100 in accordance with one embodiment of the present invention. As shown in FIG. 1, an advertisement hosting website 100 comprises a front end interface 110, an analysis module 120, an advertisement generation module 130, an advertisement search module 140, an advertisement database 150 and a geographic information database 160. Many conventional features, such as firewalls, load balancers, application servers, failover servers, site management tools and so forth are not shown so as not to obscure the features of the system. An example advertisement hosting website 100 for implementation of the system is for example, found at www.Outside.In. The examples disclosed herein may be applied to other advertisement hosting websites that are known as well. It will be understood that the term “web site” represents any computer system adapted to serve content using any internetworking protocols, and is not intended to be limited to content uploaded or downloaded via the Internet or the HTTP protocol. In general, functions described in one embodiment as being performed on the server side can also be performed on the client side in other embodiments if appropriate. In addition, the functionality attributed to a particular component can be performed by different or multiple components operating together.

Each of the various modules are implemented as part of a server program executing on server-class computer comprising a central processing unit (CPU), memory, network interface, peripheral interfaces, and other well known components. The computers themselves preferably run an open-source operating system such as LINUX, have generally high performance CPUs, 1 G or more of memory, and 100 G or more of disk storage. Of course, other types of computers can be used, and it is expected that as more powerful computers are developed in the future, they can be configured in accordance with the teachings herein. The functionality implemented by any of the elements can be provided from computer program products that are stored in tangible computer accessible storage mediums (e.g., RAM, hard disk, or optical/magnetic media).

A client 180 executes a browser 185 and can connect to the front end interface 110 via a network 170, which is typically the internet, but can also be any network, including but not limited to any combination of a local area network (LAN), a metropolitan area network (MAN), a wide area network (WAN), a mobile, wired or wireless network, a private network, or a virtual private network. While only a single client 180 and browser 185 are shown, it is understood that very large numbers (e.g., millions) of clients are supported and can be in communication with the advertisement hosting website 100 or websites 190 at any time. The client 180 may include a variety of different computing devices. Examples of client devices 180 are personal computers, digital assistants, personal digital assistants, cellular phones, mobile phones, smart phones or laptop computers. As will be obvious to one of ordinary skill in the art, the present invention is not limited to the devices listed above.

A browser 185 can include any application that allows users of client 180 to access web pages on the World Wide Web. Suitable applications are MICROSOFT INTERNET EXPLORER, NETSCAPE NAVIGATOR, MOZILLA FIREFOX, APPLE SAFARI or any application adapted to allow access to web pages on the World Wide Web. A user can access web pages on the advertisement hosting website 100 or on website 190. Though only one website is shown, it is understood that very large numbers (e.g., millions) of websites are supported and can be in communication with the client 180 or advertisement hosting website 100. Website 190 may be affiliated with the advertisement hosting website 100 and is adapted to include geocoded targeted web advertisements generated by the advertisement hosting website 100 in web pages hosted by website 190. For purposes of convenience and description of one embodiment, the users of client 180 and browser 185 will be referred to as a “user” or “users.” In the context of the present discussion, users will be accessing web pages on website 190 and the advertisement hosting website 100 will include geocoded targeted advertisements in the web pages hosted by website 190. Note that users may access web pages that include geocoded targeted advertisements from the advertisement hosting website 100.

When a user accesses a web page on website 190 via the network 170, the front end interface 110 of the advertisement hosting website 100 provides geocoded targeted web advertisements to website 190 to include in the web page requested by the user. The front end interface 110 is responsible for communication between the various modules within the advertisement hosting website 100 and websites 190.

Once a web page requested by the user is loaded in the browser 185, the analysis module 120 is responsible for determining geographic information within the content of the web page. In one embodiment, the analysis module 120 determines a geographic location from the content displayed in the web page, for example, a neighborhood or city, referenced within the content. The geographic location can be determined from content displayed on the webpage such as text or images. In a further embodiment, the geographic location may be received via user input. The geographic location determined from the content of the webpage may be an indication of a geographic location of relevance to the user. Additionally, the analysis module 120 searches the geographic information database 160 to determine the latitude and longitude coordinates of the geographic centroid (i.e., centerpoint) associated with the geographic location.

The geographic information database 160 is responsible for storing geographic information of various geographic locations. In one embodiment, the geographic information database 160 stores latitude and longitude coordinates associated with the geographic centroid of various neighborhoods. For example, the geographic information database 160 may store the latitude and longitude coordinates corresponding to the centroid of the Evergreen neighborhood in San Jose, Calif. The latitude and longitude coordinates of a neighborhood's centroid is utilized to determine appropriate web advertisements that are geocoded to correspond to the coordinates of the neighborhood. In an embodiment, the geographic information database 160 also stores the boundaries of the geographic locations such as a neighborhood, for example. Generally, a neighborhood is a geographically localized community located within a larger community, such as a city. Neighborhoods typically comprise common characteristics such as a particular culture, diversity or economic characteristics that distinguish one neighborhood from another. In an embodiment, the neighborhoods stored in the geographic information database 160 are defined by a boundary-box system provided by a mapping company, such as Maponics, Inc., that defines neighborhoods within a geographic area.

Additionally, the geographic information database 160 may also store latitude and longitude coordinates associated with the geographic centroid of various cities. Alternatively, the latitude and longitude coordinates of a city may be utilized to localize web advertisements to a specific area within the city in the instance that a neighborhood cannot be determined from the content of a web page. In one embodiment, the latitude and longitude coordinates stored in the geographic information database 160 is based on established (i.e., pre-calculated) latitude and longitude coordinates that correspond to the centroids of neighborhoods and cities. The latitude and longitude coordinates may be maintained by a system administrator of the advertisement hosting website 100.

The advertisement search module 140 is responsible for determining web advertisements that are relevant to latitude and longitude coordinates corresponding to a geographic location, such as a neighborhood. In one embodiment, the advertisement search module 140 searches the advertisement database 150 for geographic specific advertisements that correspond to latitude and longitude coordinates of a neighborhood's centroid. Additionally, the advertisement search module 140 searches the advertisement database 150 for geographic specific advertisements that correspond to latitude and longitude coordinates of a city's centroid. Furthermore, the advertisement search module 140 determines a general advertisement campaign associated with a company's geographic specific advertisements. The general advertisement campaign comprises an advertisement template that is relevant to every location of a particular company.

The advertisement database 150 stores both general advertisement campaigns (e.g., general advertisement templates) and geographic specific advertisements that are associated with the general advertisement campaigns. The general advertisement campaigns generally consist of generic advertisement information of a company that would be relevant to any advertisement pertaining to that company. For example, the general advertisement campaign may include the logo of the company, name of the company or a generic phrase such us “at your (insert neighborhood) Store, Inc. store!” In contrast, geographic specific advertisements may be specific store locations, names of neighborhoods or specific promotions that only pertain to a specific store location such as the phrase “Buy 1 get one FREE!”

In one embodiment, the advertisement database 150 stores geographic specific advertisement tables. Each geographic specific advertisement table is associated with latitude and longitude coordinates that corresponds to a geographic location's centroid. The geographic location associated with each table indicates defined boundaries of the geographic location. The geographic specific advertisement tables contain data records of the various companies that are located within the boundaries of the geographic location associated with the table. In each company's data record, the advertisement database 150 stores geographic specific advertisements that pertain to only one location of a company that resides within the boundaries of the geographic location associated with the geographic specific advertisement table. Additionally, each company's data record comprises an address of that company's particular location. Note that each company's data record may contain information regarding the company's multiple locations that are located within the geographic location. Geographic specific advertisements are, for example, promotions, sales or offers that are only offered at a specific location of a company or at multiple instances of a company near the geographic location's centroid. Additionally, metadata such as keywords that describe a company or the products or services associated with the company may be stored. For example, metadata for a Best Buy electronics store may include the keywords “electronics,” “mp3 players,” “dvds,” “Blu-ray,” “lcd tv,” etc.

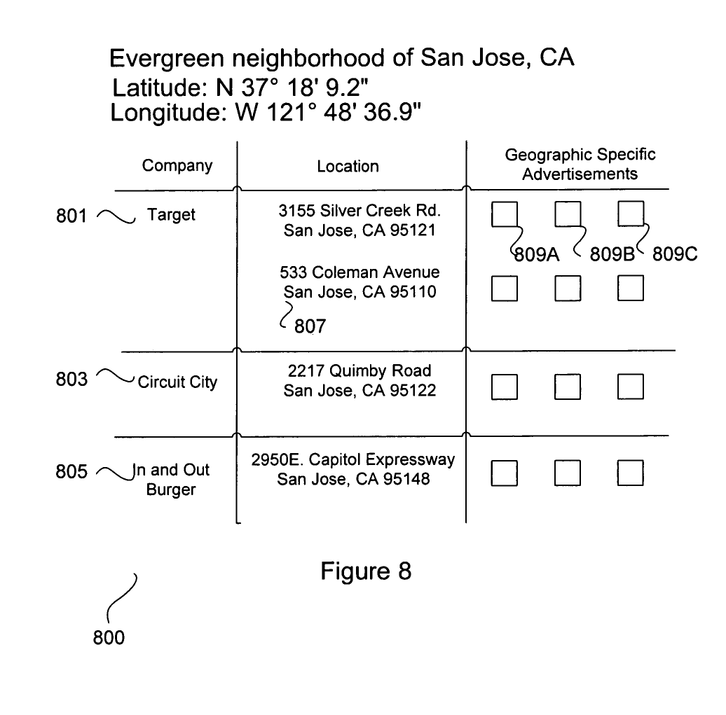

Referring to FIG. 8 illustrates an example of a geographic specific advertisement table 800 that may be associated with the latitude and longitude coordinates of the Evergreen neighborhood of San Jose, Calif. The geographic specific advertisement table 800 may include for example the data records for companies such as Target 801, Circuit City 803, and In and Out Burger 805 that reside within the Evergreen neighborhood. Each of the data records in the table would then contain the geographic specific advertisements associated with each company, metadata and the location of the company. For example, the data record for Target 801 may include a location 807 of “533 Coleman Avenue San Jose, Calif. 95110” and geographic specific advertisements 809A, 809B and 809C.

Additionally, in one embodiment, the advertisement database 150 also stores a general advertisement table with a record of all the companies that are affiliated with the advertisement hosting website 100. Each data record in the general advertisement table that is associated with an individual company includes a company's general advertisement campaign. A general advertisement campaign is an advertisement template that is relevant to every location of a particular company.

Once the geographic specific advertisements and their corresponding general advertisement campaign are determined by the advertisement search module 130, the advertisement generation module 130 is responsible for compiling the geographic specific advertisements and the general advertisement campaign to generate a geocoded targeted web advertisement. Geocoded targeted web advertisements are advertisements that correspond to a specific geographic area. Specifically, geocoded targeted web advertisements are advertisements that correspond to specific latitude and longitude coordinates of a neighborhood or city's centroid. The geocoded targeted web advertisements illustrate advertisement information such as promotions, sales, or inventory that pertains to a specific store near the centroid. For example, a geocoded targeted web advertisement may illustrate a promotion that a Circuit City store in the Evergreen neighborhood of the city of San Jose, Calif. may be having a sale on all flat screen televisions. Once the geocoded targeted web advertisement is created, the advertisement generation module 130 sends the advertisement to the front end interface 110, which proceeds to include the geocoded targeted web advertisement in the web page being viewed by the user on website 190.

### Geocoded Targeted Web Advertisement Generation Process

The geocoded targeted web advertisement generation process of the advertisement hosting website 100 determines web advertisements based on geographic information located within the content of web pages viewed by users. The process performed by the advertisement hosting website 100 to generate geocoded targeted web advertisements is further described below.

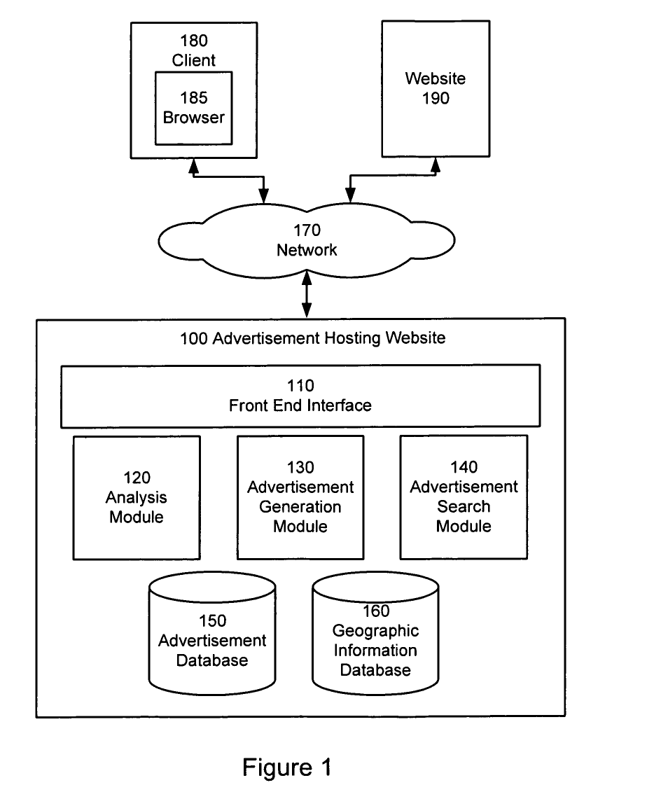

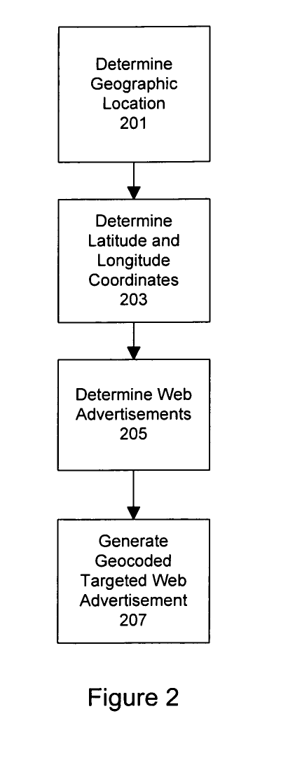

Referring now to FIG. 2, the advertisement hosting website 100 performs the functional stages to generate geocoded targeted web advertisements: 201: Determine geographic location; 203: Determine latitude and longitude coordinates; 205: Determine web advertisements; and 207: Generate geocoded targeted web advertisement. Each of these stages will now be described in further detail.

At the first stage 201, the analysis module 120 determines a geographic location associated with the user from the content of the web page that was loaded by the user. In one embodiment, the geographic location may be a neighborhood. A user may access a web page on website 190 by entering a URL link of a website into the browser 185. Alternatively, the user may access a web page on website 190 by querying a search engine which displays a list of article identifiers that are associated with web pages on website 190 and selecting one of the article identifiers.

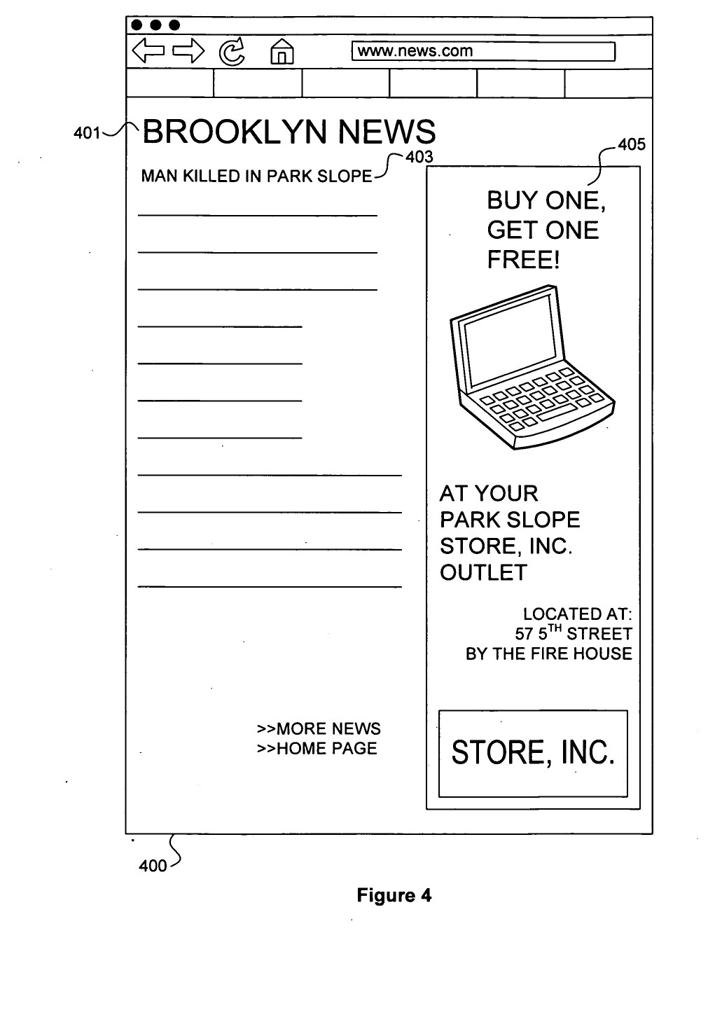

Referring to FIG. 4, there is shown an example website 400 including a geocoded targeted web advertisement 405 that was loaded by a user. In one embodiment, to generate the geocoded targeted web advertisement 405, the analysis module 120 determines a neighborhood associated with the user from the content of the web page. Generally, in the present invention, the content of a web page is analyzed to determine a geographic location. These locations are indications of geographic locations of relevance to the user. Thus, web advertisements that correspond to the geographic location will be of the most interest to the user.

Typically, many users display web pages that are relevant to them in some manner. The content of the web pages can be utilized to determine a geographic location of interest to the user. In FIG. 4, the website illustrates a news article from the Brooklyn News. In one embodiment, the analysis module 120 parses the content of the web page 400 for a geographic location such as a neighborhood. The analysis module 120 determines geographic locations by comparing keywords in the content of the web page indicative of a neighborhood stored in the geographic information database 160. The comparison ensures that the keyword determined by the analysis module 120 is an actual neighborhood or geographic location within the geographic information database 160. In the news article example, the analysis module 120 determines that the neighborhood associated with the user is “Park Slope” from the title of the news article. The keyword “Park Slope” is a strong indication that the user has some relationship to the neighborhood as the user is reading a news article that pertains to the neighborhood.

Referring back to FIG. 2, at the second stage 203, the analysis module 120 determines latitude and longitude coordinates associated with the determined neighborhood's centroid. Once the analysis module 120 determines a neighborhood within the content of a web page, the analysis module 120 refers back to the geographic information database 160. The analysis module 120 searches the geographic information database 160 for geographic information regarding the latitude and longitude coordinates of the determined neighborhood's centroid. The latitude and longitude coordinates of the neighborhood's centroid is determined in order to establish web advertisements that are associated with that particular neighborhood as will be further described below. Generally, the latitude and longitude coordinates of a neighborhood's center point allows web advertisers to determine web advertisements that are more likely to be relevant to the user viewing the web page, thus creating a more effective advertisement campaign. Furthermore, targeting web advertisements at a neighborhood level allows web advertisers to account for the variation in promotions, sales or products offered in different neighborhoods.

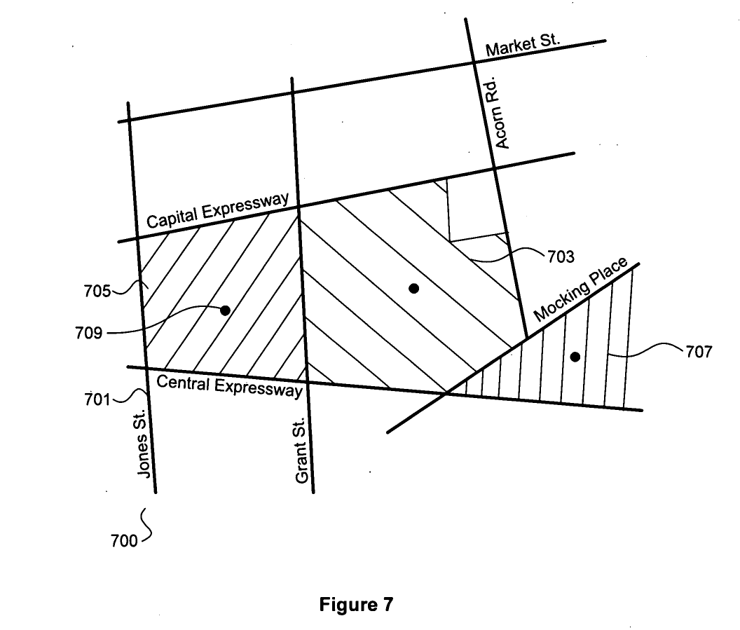

Referring to FIG. 7, there is shown a diagram 700 illustrating various neighborhoods depicted by trapezoidal regions that include each neighborhood's centroid. As previously mentioned, the neighborhoods may be defined by a boundary-box system provided by a mapping company, such as Maponics, Inc., that determines neighborhoods within a geographic location. FIG. 7 illustrates neighborhood A 703, neighborhood B 705 and neighborhood C 707. The boundaries of each neighborhood are defined by various streets 701. The centroid 709 corresponds to latitude and longitude coordinates that represents the centerpoint of the neighborhood. In one embodiment, the centroid is predefined based on the vertices of the polygon which corresponds to the neighborhood. In an alternative embodiment, the centroid of the neighborhood may be associated with the most densely populated area of the neighborhood. In one embodiment, the predefined centroid may be compared to the densely populated area of the neighborhood by a system administrator of the advertisement hosting website 100. The centroid may be shifted to the area corresponding to the densely populated area of the neighborhood if the predefined centroid is not within a distance threshold. The location within the neighborhood with the highest population may be considered the centerpoint as highly populated areas generally indicate the location of businesses which are relevant to the web advertisements being displayed. Additionally, the centroid may simply be defined by the system administrator of the advertisement hosting website 100.

Referring back to FIG. 2, at the third stage 205 of the geocoded targeted web advertisement generation process, web advertisements associated with the latitude and longitude coordinate of the neighborhood's centroid are determined. Geocoded targeted web advertisements are advantageous both to web advertisers and users viewing the advertisement. As many companies have various locations, with each location offering different promotions, services, sales or inventory, it is inefficient and costly for the advertisers to spend the resources to generate an individual advertisement campaign for every location of the company and to determine where to serve these advertisements. Geocoded targeted web advertisements allow web advertisers to generate a single general advertisement campaign for a company that is automatically adjusted to reflect the geographic specific location, such as a neighborhood, associated with a user. Thus, web advertisers simply need to develop a general advertisement template, as will be further discussed below, that can be automatically adapted to incorporate geographic specific advertisements. This in turn provides users with advertisements that are potentially relevant. For example, a user who is displayed a $5 car wash advertisement that is located within their neighborhood is much more relevant to the user than a $5 car wash advertisement that is located in another state, city, or even different points of a city.

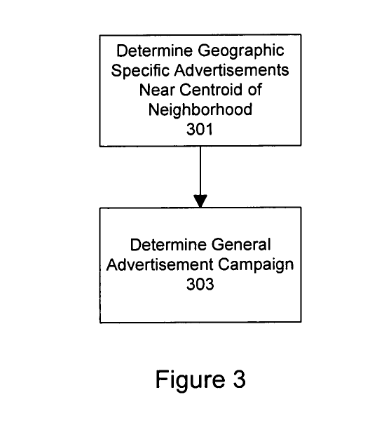

FIG. 3 is representative of the steps performed to determine web advertisements associated with a specific neighborhood. The following steps are performed to determine the neighborhood specific web advertisements: 301: Determine geographic specific advertisements near centroid of neighborhood; and 305: Determine general advertisement campaign. Each step is further described below.

In step 301, the advertisement search module 140 determines geographic specific advertisements near an identified centroid of a neighborhood. As previously mentioned the advertisement database 150 contains geographic specific advertisement tables that contain data records of the various companies that that are located near specific latitude and longitude coordinates that represent a geographic centroid of a neighborhood. Generally, the advertisement search module 140 locates companies within the geographic specific advertisement tables that are associated with the latitude and longitude coordinates of the determined neighborhood's centroid. In one embodiment, the geographic specific advertisements associated with the company located nearest to the centroid of the neighborhood are selected. The advertisement search module 140 simply searches the advertisement database 150 for any company within a boundary or predefined region near the centroid based on their specific location and identifies which company is the shortest distance away from the centroid of the neighborhood.

In one embodiment each company that is associated with the advertisement hosting website 110 has their associated cost per number of advertisement impressions stored in the appropriate data record in the advertisement database 150. The cost per number of advertisement impressions indicates the amount of money paid to the website 100 per number of advertisements displayed on the advertisement hosting website 100. In one embodiment, the advertisement search module 140 searches the advertisement database 150 for any company within a boundary or predefined region near the centroid based on their specific location and identifies which company offers the highest cost per number of advertisement impressions.

In another embodiment, the advertisement search module 140 locates geographic specific advertisements of store locations of a predetermined company. The geographic specific advertisements associated with the store location of the predetermined company closest to the centroid may be chosen as agreements between a website 190 in which a geocoded targeted web advertisement will be displayed and the advertisement hosting website 100 may require that only a particular company is allowed to advertise on the website 190.

In one embodiment, companies associated with the advertisement hosting website 100 may send an estimate of each location's current sales and the sales information is stored in the appropriate data record in the advertisement database 150. The advertisement search module 140 may select the specific advertisements of a company that is within the neighborhood based on some predetermined criteria corresponding to the company's sales information. For example, geographic specific advertisements of a company within the neighborhood with the lowest sales may be selected in an effort to increase sales at that particular location. Alternatively, companies within a neighborhood may bid against one another to determine which companies' advertisements will be associated with the centroid of a neighborhood. The company that won the bid may have various locations within the neighborhood and the location with the lowest sales will have their geographic specific advertisements selected.

In an alternative embodiment, agreements between a website 190 in which a geocoded targeted web advertisement will be displayed and the advertisement hosting website 100 may require that only approved companies that are pre-authorized by the owner's or system administrator of the website are allowed to display their advertisements on the website. The advertisement search module 140 may search the data records associated with the centroid of the determined neighborhood for neighborhood specific advertisements of the approved companies. In the case where multiple approved companies are located within the neighborhood or multiple instances of the same approved company are located, the neighborhood specific advertisements associated with the location closest to the centroid are selected.

In another alternative embodiment, neighborhood specific advertisements are selected based on pre-set search queries. An administrator of the advertisement hosting website 100 or of website 190 may require that only advertisements associated with specific keywords are to be displayed. For example, an agreement may be made that only advertisements related to “electronics” will be displayed on a website. The advertisement search module 140 analyzes the metadata in the data records of the specific advertisement table associated with the determined centroid for the required keyword. Once the companies that include the required keyword are determined, the neighborhood specific advertisements associated with the location closest to the centroid are selected.

In step 303, the advertisement search module 140 searches the advertisement database 150 to determine a general advertisement campaign that corresponds to the geographic specific advertisements that were determined in step 301. Specifically, the advertisement search module 140 searches the general advertisement table in the advertisement database 150 for the general advertisement campaign that corresponds to the company that is associated with the geographic specific advertisements determined in step 301. Once the appropriate general advertisement campaign is acquired, a geocoded targeted web advertisement is generated as will be further described below.

Referring back to FIG. 2, generally in the final stage 207 of the geocoded targeted web advertisement generation process, the advertisement generation module 130 generates a geocoded targeted web advertisement. Specifically, in stage 207, the advertisement generation module 130 generates a neighborhood focused web advertisement from the geographic specific advertisements and general advertisement campaign determined in steps 301 and 303 of the third stage of the geocoded targeted web advertisement generation process that was previously described above.

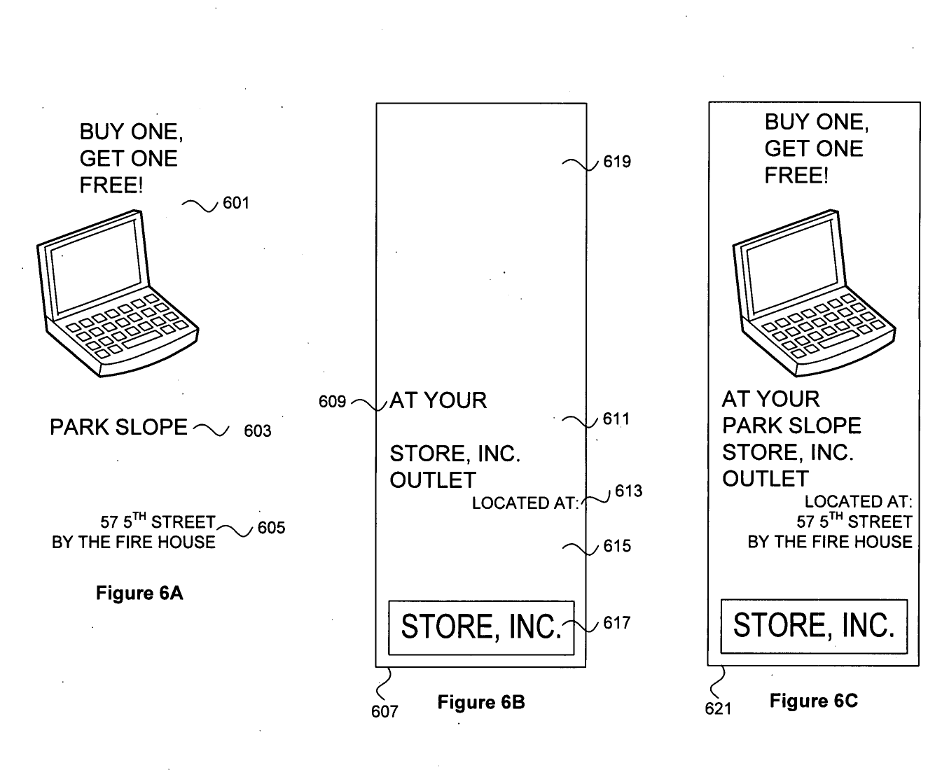

Referring now to FIG. 6, there is shown one embodiment of a pictorial representation of geographic specific advertisements shown in FIG. 6A that are neighborhood focused, a general advertisement campaign shown in FIG. 6B and a neighborhood focused web advertisement shown in FIG. 6C. The examples shown in FIGS. 6A-C correspond to the news article example illustrated in FIG. 4. Note that in FIG. 4, the neighborhood information determined in second stage 203 associated with the city of Brooklyn was the Park Slope neighborhood.

In this example, during the third stage 205 of the geocoded targeted web advertisement generation process, the advertisement search module 140 determined the geographic specific advertisements shown in FIG. 6A that are associated with a company “Store, Inc.” located in the neighborhood of Park Slope. In one embodiment, this particular location may correspond to the company nearest to the centroid of the Park Slope neighborhood. Generally, the geographic specific neighborhood advertisements comprise of various advertisement types such as specific store locations, neighborhood name or specific promotions that only pertain to a specific store. Note, that the advertisement types described above are not all inclusive and any appropriate type of advertisement can be used.

In the “Store, Inc.” example, the specific neighborhood advertisements comprise a promotion 601 specific to the Park Slope location of Store, Inc. that indicates the promotion “Buy one, get one FREE!,” a neighborhood location 603 of “Park Slope” and/or a company location 605 of “57, 5^{th} Street by the Firehouse.” In one embodiment, each of the specific neighborhood advertisements described above are assigned an advertisement identification (ID) number that corresponds to a type of specific neighborhood advertisement. The advertisement ID will be used to map the specific neighborhood advertisements to the correct location within the general advertisement campaign, as will be further described below.

FIG. 6B illustrates one embodiment of a general advertisement campaign. The example in FIG. 6B illustrates a general advertisement campaign 607 for the company Store, Inc. The general advertisement campaign allows web advertisers to create a general advertisement that is applicable to every location of a particular company. The general advertisement campaign includes general information that is relevant to every location of a particular company and is essentially an advertisement template. In the Store, Inc. example, the general advertisement campaign 607 includes the company logo 617, a generic neighborhood slogan 609 reciting the phrase “At Your (insert neighborhood location) Store, Inc. Outlet,” and a location slogan 613 reciting “Located At.” The general advertisement campaign also includes specified areas that are designated for specific neighborhood advertisement types that were previously described above. In the Store, Inc. example, a promotion region 619 is included for any promotions, special offers, sales or inventory selection that is specific to a particular store. Additionally, within the generic neighborhood slogan 609 is a neighborhood location region 611 that is used for placement of the neighborhood location of the particular store. The general advertisement campaign also includes a company location region 615 that is used for placement of the address location of the store. Note that the specified areas for specific neighborhood advertisement mentioned above are used for exemplary purposes only and any appropriate format for placement of specific neighborhood advertisements can be used.

As previously mentioned, in one embodiment each of the specific advertisements is assigned an advertisement identification (ID) number that corresponds to a type of specific neighborhood advertisement. The advertisement IDs are used to correctly map each type of specific neighborhood advertisement to its corresponding location in the general advertisement campaign. The corresponding location in the general advertisement campaign is also assigned the same advertisement ID as its corresponding specific neighborhood advertisement. The advertisement generation module 130 essentially maps each specific neighborhood advertisement to the corresponding location in the general advertisement campaign that includes the same advertisement ID. In the Store, Inc. example, the promotion 601 may be assigned an advertisement ID value of 1, for example. Accordingly, the promotion region 619 in the general advertisement campaign 607 may also be assigned an advertisement ID value of 1. The advertisement generation module 130 would then overlay the promotion 601 onto the promotion region 619 during the creation of the geocoded targeted web advertisement. In the same manner, the advertisement generation module 130 would map the neighborhood location 603 to the neighborhood location region 611 and would also map the company location 605 to the company location region 615.

Once the advertisement generation module 130 has mapped the neighborhood specific advertisements to their respective locations, the geocoded targeted web advertisement is complete. Referring to FIG. 6C, there is shown one embodiment of an example of a geocoded targeted web advertisement. Using the neighborhood specific advertisements 601, 603 and 605 depicted in FIG. 6A and the general advertisement campaign 607 shown in FIG. 6B, the advertisement generation module 130 has generated a neighborhood specific advertisement 621 for the company Store, Inc. shown in FIG. 6C. The neighborhood specific advertisement 621 includes a promotion specific to only the Park Slope location of the company Store, Inc. and the location for the Park Slope store. Note, that the neighborhood specific advertisement 621 is generated in response to the determination of the Park Slope neighborhood 403 within the content of the web page 400 in FIG. 4. Thus, the user viewing the news article illustrated in FIG. 4 is also shown a geocoded targeted web advertisement that is specific to the Park Slope neighborhood. In an alternative embodiment, the neighborhood specific advertisement 405 may be displayed in a separate web page as a pop up, new tab, or new window rather than being displayed on the web page containing the news article that is being viewed by the user.

Note that the embodiments discussed above in reference to generating a geocoded targeted web advertisement associated with a centroid of a neighborhood may be extended to embodiments where a neighborhood cannot be determined. For example, the analysis module 120 may determine a city from the content of a webpage rather than a neighborhood. The latitude and longitude coordinates of the city's centroid would be determined and the embodiments discussed above in regard to generating a neighborhood specific web advertisement would be performed to generate web advertisements corresponding to the centroid of a city.

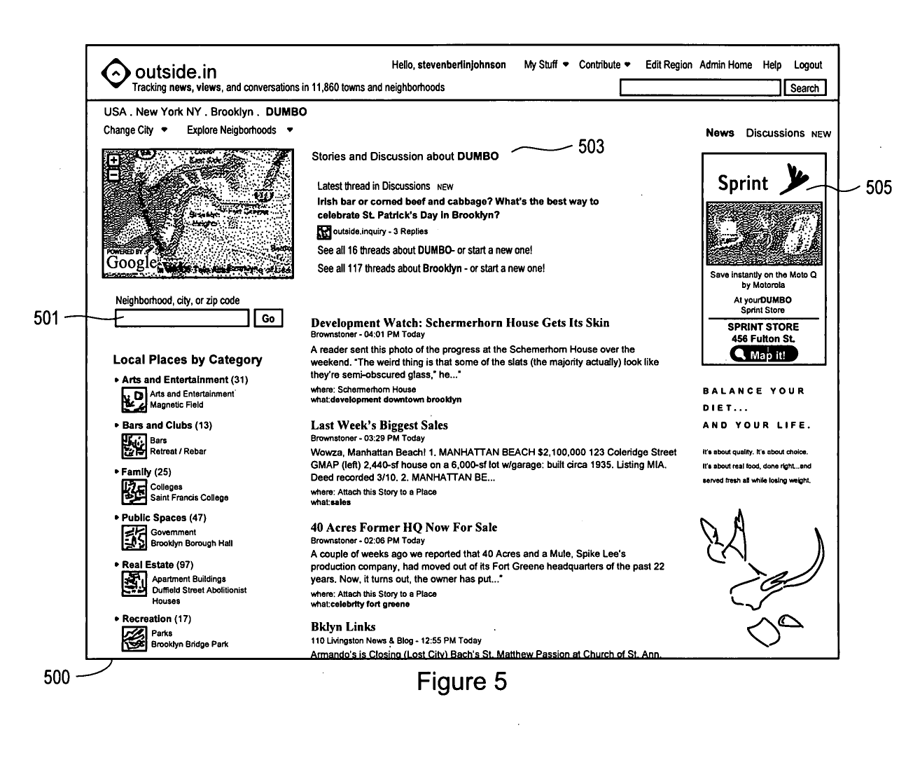

As previously discussed, during the geocoded targeted web advertisement generation process, the analysis module 120 determines geographic location information, such as a neighborhood, that is associated with a user from a web page being browsed by the user. In one embodiment, geographic location information can be explicitly entered by the user and will be received by the analysis module 120. Referring now to FIG. 5, there is shown one embodiment of a web page that allows users to enter geographic locations of interest which prompt the display of neighborhood specific advertisements. The example shown in FIG. 5 illustrates an information web page 500 hosted by the advertisement hosting website 100. The information web page 500 includes a location data entry field 501 that allows users to enter a neighborhood, city or zip code to receive stories or discussions relevant to the entered location. In the example shown in FIG. 5, the user has entered the neighborhood of Dumbo 503 in the location data entry field 501. The information web page 500 illustrates to the user stores and discussions relevant to the neighborhood of Dumbo in Brooklyn, N.Y. The advertisement hosting website then proceeds to generate a neighborhood specific advertisement 505 for the neighborhood of Dumbo using the methods previously described above.

The features described herein beneficially provide a system and method to generate geocoded targeted web advertisements. Generating advertisements that are neighborhood specific provides users viewing the advertisements the most relevant promotions or offers. A user no longer is displayed web advertisements that may be interesting, but the promotions or sales within the advertisements are not accessible as the advertisements correspond to stores or locations that are not within the vicinity of the user. Additionally, the system and methods described above allow web advertisers to generate a single advertisement campaign for companies that can be automatically adjusted to reflect promotions, sales, etc. that are relevant only to a specific location of a company. Therefore, valuable time and money is not wasted in creating advertisement campaigns for each specific store location.

Some portions of above description describe the embodiments in terms of algorithms and symbolic representations of operations on information, for example, the processes described and illustrated through FIGS. 2 through 7. These algorithmic descriptions and representations are commonly used by those skilled in the data processing arts to convey the substance of their work effectively to others skilled in the art. These operations, while described functionally, computationally, or logically, are understood to be implemented by computer programs (e.g., as instructions) or equivalent electrical circuits, microcode, or the like and are executed by a processor or other like device. Furthermore, it has also proven convenient at times, to refer to these arrangements of operations as modules, for example as in FIG. 1, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a method for generating neighborhood specific advertisements based on the context of web pages being viewed by a user through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method of generating a geocoded targeted web advertisement for a user viewing web pages, the method comprising:
determining a geographic location from content of a web page;
searching for geographic information associated with the geographic location;
determining coordinates associated with a centroid of the geographic location from the geographic information;
identifying geographic specific advertisements associated with the centroid; and
generating a geocoded targeted web advertisement for display to the user based at least in part on the geographic specific advertisements.

2. The computer-implemented method of claim 1, the method further comprising identifying a general advertisement of an entity that corresponds to the identified geographic specific advertisements.

3. The computer-implemented method of claim 2, wherein the geocoded targeted web advertisement is based on the geographic specific advertisements and the general advertisement.

4. The computer-implemented method of claim 3, wherein the geographic specific advertisements are web advertisements that are associated with a particular entity location and the general advertisement is an advertisement template associated with the entity.

5. The computer-implemented method of claim 1, wherein the coordinates associated with a centroid of the geographic location are latitude and longitude coordinates.

6. The computer-implemented method of claim 1, wherein the geographic location is a geographically localized community located within a larger community.

7. The computer-implemented method of claim 1, wherein identifying geographic specific advertisements further comprises identifying geographic specific advertisements associated with an entity that is a shortest distance from the coordinates of the centroid.

8. The computer-implemented method of claim 1, wherein identifying geographic specific advertisements further comprises identifying current sales of entities located near the coordinates of the centroid.

9. The computer-implemented method of claim 1, wherein identifying geographic specific advertisements further comprises identifying geographic specific advertisements associated with a company with a highest cost per number of advertisement impressions.

10. The computer-implemented method of claim 1, wherein identifying geographic specific advertisements further comprises identifying whether an entity associated with the geographic specific advertisements is an approved entity that is preauthorized to display their geographic specific advertisements on the website.

11. A computer readable storage medium storing a computer program product configured to store instructions for generating a geocoded targeted web advertisement for a user viewing web pages, instructions when executed by a processor cause the processor to:
determine a geographic location from content of a web page;
search for geographic information associated with the geographic location;
determine coordinates associated with a centroid of the geographic location from the geographic information;
identify geographic specific advertisements associated with the centroid; and
generate a geocoded targeted web advertisement for display to the user based at least in part on the geographic specific advertisements.

12. The computer readable medium of claim 11 further comprising identifying a general advertisement of an entity that corresponds to the identified geographic specific advertisements.

13. The computer readable medium of claim 12, wherein the geocoded targeted web advertisement is based on the geographic specific advertisements and the general advertisement.

14. The computer readable medium of claim 11, wherein the geographic specific advertisements are web advertisements that are associated with a particular entity location and the general advertisement is an advertisement template associated with the entity.

15. The computer readable medium of claim 11, wherein the coordinates associated with a centroid of the geographic location are latitude and longitude coordinates.

16. The computer readable medium of claim 11 wherein the geographic location is a geographically localized community located within a larger community.

17. The computer readable medium of claim 11 wherein identifying geographic specific advertisements further comprises identifying geographic specific advertisements associated with an entity that is a shortest distance from the coordinates of the centroid.

18. The computer readable medium of claim 11 wherein identifying geographic specific advertisements further comprises identifying current sales of entities located near the coordinates of the centroid.

19. The computer readable medium of claim 11 wherein identifying geographic specific advertisements further comprises identifying geographic specific advertisements associated with a company with a highest cost per number of advertisement impressions.

20. The computer readable medium of claim 11 wherein identifying geographic specific advertisements further comprises identifying whether an entity associated with the geographic specific advertisements is an approved entity that is preauthorized to display their geographic specific advertisements on the website.

21. A system for generating a geocoded targeted web advertisement for a user viewing web pages, the system comprising:
a geographic information database storing geographic information of various geographic locations;
an analysis module adapted to:
determine a geographic location from content of a web page;
search the geographic information database for geographic information associated with the geographic location;
determine coordinates associated with a centroid of the geographic location from the geographic information;
an advertisement search module that identifies geographic specific advertisements associated with the centroid; and
an advertisement generation module that generates a geocoded targeted web advertisement for display to the user based at least in part on the geographic specific advertisements.

22. The system of claim 21, wherein the advertisement search module is further adapted to identify a general advertisement of an entity that corresponds to the identified geographic specific advertisements.

23. The system of claim 22, wherein the geocoded targeted web advertisement is based on the geographic specific advertisements and the general advertisement.

24. The system of claim 21, wherein the geographic specific advertisements are web advertisements that are associated with a particular entity location and the general advertisement is an advertisement template associated with the entity.

25. The system of claim 21, wherein the coordinates associated with a centroid of the geographic location are latitude and longitude coordinates.

26. The system of claim 21, wherein the geographic location is a geographically localized community located within a larger community.

27. The system of claim 21, wherein the advertisement search module that identifies geographic specific advertisements is further adapted to identify geographic specific advertisements associated with an entity that is a shortest distance from the coordinates of the centroid.

28. The system of claim 21, wherein the advertisement search module that identifies geographic specific advertisements is further adapted to identify current sales of entities located near the coordinates of the centroid.

29. The system of claim 21, wherein the advertisement search module that identifies geographic specific advertisements is further adapted to identify geographic specific advertisements associated with a company with a highest cost per number of advertisement impressions.

30. The system of claim 21, wherein the advertisement search module that identifies geographic specific advertisements is further adapted to identify whether an entity associated with the geographic specific advertisements is an approved entity that is preauthorized to display their geographic specific advertisements on the website.
